(19) United States
(12) Patent Application Publication
(10) Pub. No.: US 2013/0268755 A1
(43) Pub. Date: Oct. 10, 2013

(54) CROSS-PROVIDER CROSS-CERTIFICATION CONTENT PROTECTION

(71) Applicant: MICROSOFT CORPORATION, Redmond, WA (US)

(72) Inventors: John Carl Simmons, North Bend, WA (US); Hany Farag, Redmond, WA (US); Alexander Black Coyne, Woodinville, WA (US)

(73) Assignee: Microsoft Corporation, Redmond, WA (US)

(21) Appl. No.: 13/855,702

(22) Filed: Apr. 2, 2013

Related U.S. Application Data
(60) Provisional application No. 61/621,348, filed on Apr. 6, 2012.

(51) Int. Cl. H04L 29/06

(52) U.S. Cl. CPC H04L 63/0823
USPC 713/156

(57) ABSTRACT

Access to protected resources across client devices having different authentication systems is provided. An authorization provider creates cross-certificates to trusted public keys provided by resource protection providers. Each resource protection provider installs a digital certificate on a device. This digital certificate is signed by the resource protection provider, and includes on the device a private key which are used for client authentication. Client authentication is performed by a security module on the client device digitally signing an authentication request to the authorization provider using a protection provider module-specific digital signature algorithm and providing the signed request with the device's provider-digital certificate to the authorization provider. If the authorization provider verifies the signed request and that the digital certificate is part of the authentication PKI, then the client device will be authenticated.

### BACKGROUND

Digital content providers seek to ensure that content delivered to end users is not improperly used by users. Such content comprises a protected resource—any content, media or data where the consumer uses specific rights and/or credentials in order to obtain access. There are numerous types of resource protection which may be generally classified as “service” protection and “content” protection. Service protection involves ensuring that a delivered service is provided between two trusted endpoints—securing a protected resource during delivery to a client device. Content protection involves ensuring that content already delivered to an end user is consumed by a properly entitled user. Content protection is the process of securing a protected resource subsequent to its delivery to a client device.

Difficulties arise when different protected resource providers—both media companies and delivery companies—utilize different standards, protocol and algorithms for content and service protection. It is difficult to induce all such providers to standardize on a single protection scheme.

### SUMMARY

Technology is provided which authorizes access to protected resources across client devices having different authentication systems. Each resource protection provider installs a digital certificate on a device. An authorization provider creates cross-certificates to trusted public keys provided by resource protection providers. The digital certificate is signed by the resource protection provider, and includes on the device a private key which are used for client authentication. Client authentication is performed by a security module on the client device digitally signing an authentication request to the authorization provider using a protection provider module-specific digital signature algorithm and providing the signed request with the device's protection provider-digital certificate to the authorization provider. The client proves possession of the private keys in the request through a protocol not susceptible to attack. If the authorization provider verifies the signed request and that the digital certificate is part of the authentication PKI, then the client device will be authenticated.

In one aspect, a method of protecting a resource by authenticating client devices includes receiving a plurality of public keys from one or more resource protection providers, the public keys associated with private keys accessible to client devices. Authentication certificates are issued comprising cross-certificates for the public keys and then published. The availability of a protected resource to one or more client devices is provided by authenticating client devices in response to client authentication requests. The authentication request is validated using one of said cross-certificates which cryptographically binds one of said public keys paired with one of said private key on the client.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary system for distributing media to client devices.

FIG. 2 is an exemplary system in accordance with the present technology for distributing media to client devices in a secure manner.

FIG. 3 is an exemplary topology of the systems utilized in the present technology.

FIG. 4 is a flowchart illustrating the method in accordance with the present technology.

FIG. 5 is an exemplary topology of the technology of the present technology.

FIG. 6 is an exemplary processing device for use in accordance with the present technology.

FIG. 7 is an exemplary processing device suitable for use in accordance with the technology of the present technology.

### DETAILED DESCRIPTION

Technology is provided which authorizes access to protected, multimedia resources across client devices having different authentication systems. The technology is secure, interoperable, scalable and supports nonrepudiation. In one aspect, the technology consists of two components: an authentication public key infrastructure (PKI) and a client authentication protocol which uses the authentication PKI.

An authorization provider creates the authentication PKI using cross-certificates to trusted public keys provided by protected resource (content and service) protection providers who control access to protected resources. These cross-certificates can then be used by the authorization provider to perform client authentication or authorization. In one embodiment, this is performed using open standards technologies. As used herein, protected resource providers may be media or content providing entities. Protected resource protection providers are entities which secure the content from these resource providers using specific protection schemes which may be installed on groups of client devices. An authentication provider is a third party facilitating authentication and authorization of the use of resources across potentially different protection schemes.

Authentication is the technology used to identify a client to an authorization provider. Authorization is the process that determines if a client is permitted access to specific protected resources, and depends upon client authentication.

The authorization provider, acting as a certificate authority, creates cross-certificates to trusted protected resource providers' public keys. These cross-certificates serve as root keys for branches of devices in the PKI. Cross certification enables entities in one PKI to trust entities in another PKI. This trust relationship is typically supported by a cross-certification agreement between the certification authorities (CAs) in each PKI. The agreement establishes the responsibilities and liability of each party. After at least one CA has established and specified the terms of trust and issued certificates to the other, entities within the separate PKIs can interact subject to the policies specified in the certificates. The trust relationship can be mutual.

Each protected resource provider installs a service module-specific digital certificate on a device. This digital certificate is signed by a protected resource protection provider, and provisioned on a device with the protected resource protection provider certificate and private key which are used for client authentication.

Client authentication is performed when a security module on the client device digitally signing an authentication request to the authorization provider. In one embodiment, the request takes the form of a JSON Web Token using a protected resource protection provider module-specific digital signature algorithm and providing the signed request with the device's provider-digital certificate to authorization provider. The protocol used in the request and response ensures that the client proves possession of the private keys claimed in the request in a manner not vulnerable to attack. In one embodiment, the server sends a response down to the client, and either (1) the response contains something encrypted to a public key in the client's certificate (and the client needs to decrypt it to prove possession) or (2) the response contains a value that the client needs to sign or modify-then-sign with its private key and send back to the server. If the authorization provider verifies the signed request and that the digital certificate is part of the authentication PKI, then the client device will be authenticated.

Multiple authorization providers and authentication PKIs are supported, since different authorization providers can create separate cross-certificates to the same protected resource providers' public keys.

In one aspect, the protected resource protection provider may include a Certificate Revocation List (CRL) for module-specific certificates in their branch of the PKI, which may periodically be updated for use by the authorization provider. Revocation of module-specific certificates may be performed by protected resource providers, and the authorization provider may revoke trust in a service or content provider branch or sub-branch of the authentication PKI by revoking its cross-certificate to the public key at the top of that branch.

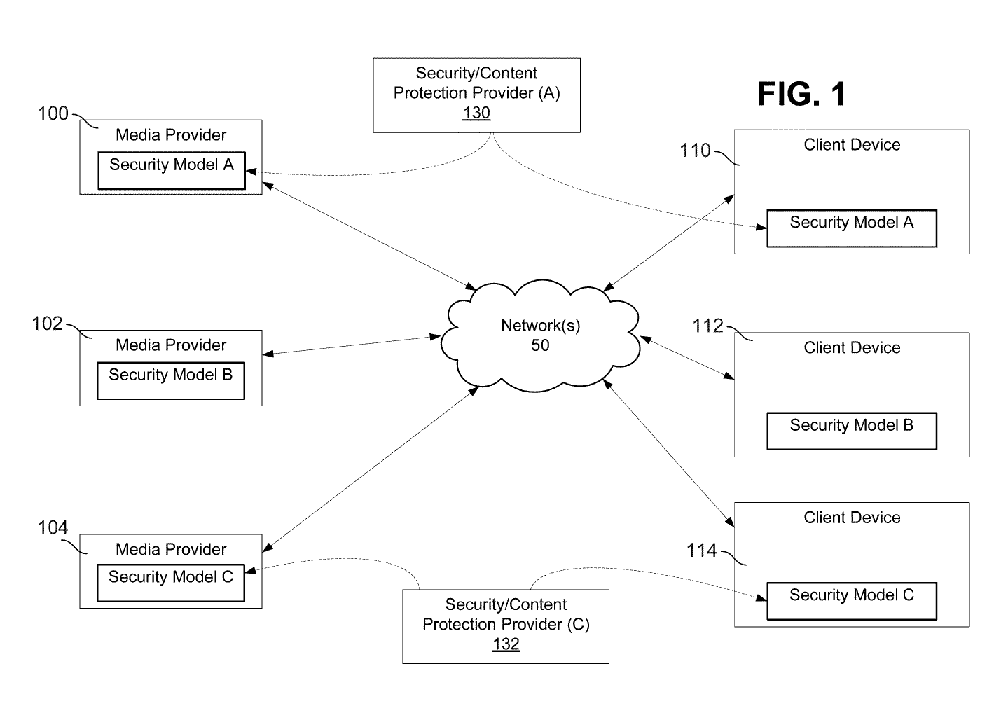

FIG. 1 illustrates one implementation of a current distribution topology for distributing protected resources such as media content to consumers using client devices.

FIG. 1 illustrates a plurality of protected resource (media) providers 100, 102, 104, each of which is using a different security model—security model A, security model B, and security model C—which is designed to securely authenticate respective client devices 110, 112, and 114. Each of the client devices 110, 112, and 114 include a corresponding respective security model—security model A, security model B, and security model C. Security model A is designed to authenticate and ensure that services or content provided from protected resource provider 100 to client device 110 are only provided to an authenticated device which can authenticate itself using security model A. Likewise, security models B and C have associated client devices 112 and 114. It should be understood there could be a plurality of media providers using security models A, B or C, as well as a plurality of client devices using each of the respective security models.

It should be further understood that the security models are not interoperable. That is, security model A from protected resource provider 100 cannot be used to authenticate or provide protected resources to client device 112, because client device 112 has been provisioned with security model B. In general, client devices 110, 112, and 114 have been provisioned with security models and associated certificate and protocols at the time of manufacture, distribution, or sometime thereafter. As such, these devices are dedicated for use by media providers using the same protocol. Although multiple media providers can use the same security models, there is no way for media providers to provide protected resources to devices having different security models.

In general, provisioning for each security model is provided by a protected resource protection provider 130, 132. Each protected resource protection provider 130,132 provides at least private keys for the security module to implement their particular security model. It should be understood that there may be multiple protected resource protection providers, each of which providing one or more security models.

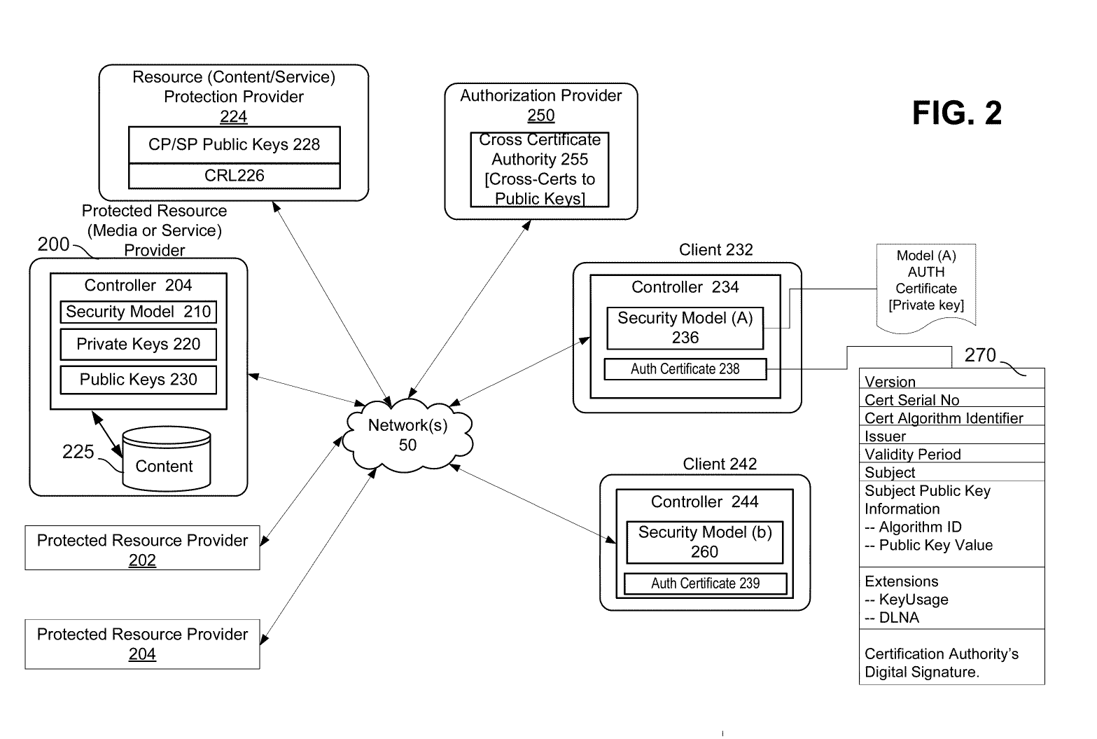

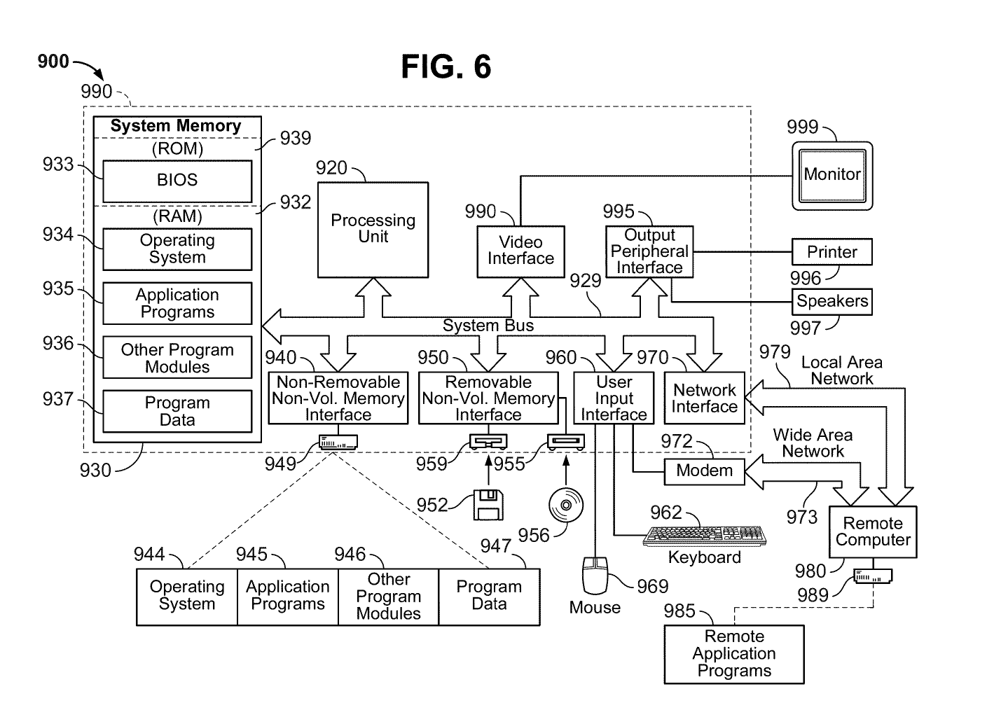

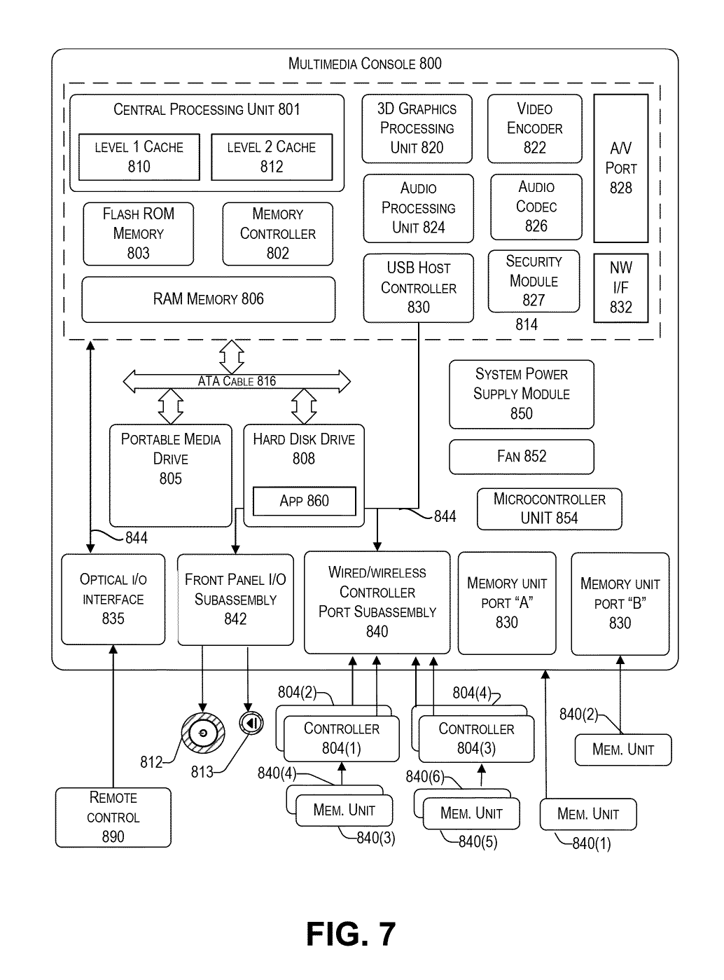

FIG. 2 illustrates a topology in accordance with the present technology. A plurality of protected resource providers 200, 202, 204 are equivalent to protected resource providers 100, 102 and 104 in FIG. 1. FIG. 200 illustrates a typical media provider in accordance with the topology of FIG. 2. Each protected resource provider will have some content 225 which they may stream or allow users having client devices to download for performance on respective client devices. A controller 214 may comprise a processing device in accordance with FIG. 6 or 7 herein, or any suitable computer implemented processing technology. Each controller 214 is designed to communicate and authenticate with clients using, for example, a discussed security model 210, private keys 220, and public keys 230. Security model 210 may comprise one of the aforementioned security models. Public and private keys are part of a PKI which is an arrangement binding public keys with identities by means a CA.

Each security module is a cryptographic module installed on a client by a protected resource provider which is in possession of an authentication certificate capable of digitally signing a communication. Protected resource providers 202 and 204 are similarly provisioned, including content, similar controllers, in the same or different security models.

In accordance with the present technology, each protected resource provider will utilize its respective security model to provide an authentication certificate and associated private keys to one or more client devices. In FIG. 2, protected resource provider 200 has the same security model—security model (A) as client device 232 and in this example, has provisioned device 232 with authentication certificate 238.

An authorization provider 250 serves as a cross-certificate authority 255 for the technology. The authorization provider 250 is an entity that authorizes and authenticates clients to access protected resources using one or more authorization servers. Each authorization server is a server which processes client authentication assertion as discussed below and may comprise one or more processing devices such as those set forth below. The authorization server can also process authorization assertions as well as authentication assertions, both of which are discussed below. Authorization provider certificate authority 255 maintains a plurality of cross-certificates.

Each cross-certificate is a digital certificate issued by the authorization provider 250 as a certificate authority that is used to sign the public key for the authentication certificate of another certificate authority, in this case the media provider (200, 202, 204). This creates a chain of trust from a single trusted certificate authority to multiple other certificate authorities. In the context of this technology, cross-certificates are utilized by authorization provider 250 to construct an authentication public key infrastructure.

In FIG. 2, two client devices 242 and 232 are illustrated. Client 232 includes a control which may be a processing device as discussed herein, the installed security model 236, in this case security model A, and an authentication certificate 238. As illustrated in FIG. 2, client 242 includes authentication model 260 having an authentication certificate 239.

In accordance with the technology, clients may be authenticated using cross-certificates to create certifications paths between authorization provider 250 and public keys of multiple protected resource providers 200, 202, 204. These keys in turn chain to X.509 leaf certificates with a common set of authentication extensions (certificate 270 in FIG. 2) which are digitally signed by the authorization provider 250 and installed with an authorization security model 236, 260 on each client device. Other forms of certificates may be utilized within the scope of the present technology.

As noted above, each client authenticates using a digitally signed communication. In the present technology, this communication is in the form of a Java Script Object Notation (JSON) web token (JWT). Java Script Object Notation is a lightweight text based open standard design for human readable data exchange. JWT is a means of representing claims to be transferred between two parties. Claims in a JWT are encoded as a JSON object that may be digitally signed using a JSON web signature and/or encrypted using a JSON web encryption. This creates an authorization provider authentication public key infrastructure and enables open ID connect private key JSON web token method for client authentication.

Authorization certificate 270 may include, for example, a version number, a certificate serial number, a certificate algorithm identifier for the certificate issuer's signature, the issuer, a validity period, the subject, public key information including the algorithm ID and public key value to be utilized to e-crypt and sign communications from the model 236 as well as the certificate of authority's digital signature. In addition, technology specific extensions include a key usage value. The key usage value is a digital signature bit which is asserted to indicate that the public key is used for verifying digital signatures other than certificates and certificate revocation lists (CRL). Additional details on the certificate are provided below.

It should be understood that the security models 236, 260 which is utilized in accordance with the present technology may be installed on a client device at the time of manufacture, at the time of provisioning by a media provider, or subsequently by updating the memory information of the controller 234, 244. For example, a flash ROM update to either of clients 232 or 242 can be utilized to install the security model in accordance with the present technology.

The topology of FIG. 2 represents an authorization provider 250 certificate authority creating an authentication public key infrastructure by utilizing cross-certificates to trusted protected resource protection provider's public key. As noted above, the authentication certificates have a standard set of attributes and a provisioned to client devices with the authentication security model along with the media provider specific certificate and private keys. Different authorization providers can create separate cross-certificates to the same set of media provider public keys. Although only one authorization provider is illustrated in FIG. 2, multiple authorization providers 250 can be utilized.

Also illustrated in FIG. 2 is a resource protection provider 224. It should be understood that there are generally multiple resource protection providers, each having public keys 228 corresponding to private keys issued to client devices as part of their particular security model.

In one aspect, each resource protection provider (content or service provider) maintains a certificate revocation list (CRL) 226 for all authorization certificates in their branch of the authorization public key infrastructure. This CRL should periodically be updated for use by the authorization provider so that revocation of certificates is solely performed by media providers. However, an authorization provider that has certificate of authority can revoke trust in any branch of a media provider or sub-branch of the public key infrastructure by revoking its cross-certificate to the media provider's public key at the top of that branch. Each protected resource provider 200, 202, 204, may maintain a copy of the CRL from the particular resource protection provider it implements.

As noted above, the technology also includes a client authentication protocol. In this context, the client will send a registration request to the authorization provider, (or more specifically an authorization server maintained by the authorization provider) as a client registration endpoint. This response can include a client identifier and a client nonce. The authorization security module on the client device inserts a nonce and a cryptographic hash of the client key in, for example, a JSON web token and digitally signed the JWT using a specific digital signature algorithm. The signed JWT and the device's authentication certificate are provided to the authorization provider (or more specifically the authorization server) as part of an open ID connect client authentication flow. If the authentication server verifies the signed JWT, that the nonce matches, and that the certificate is part of authentication PKI, then the client device has been authenticated.

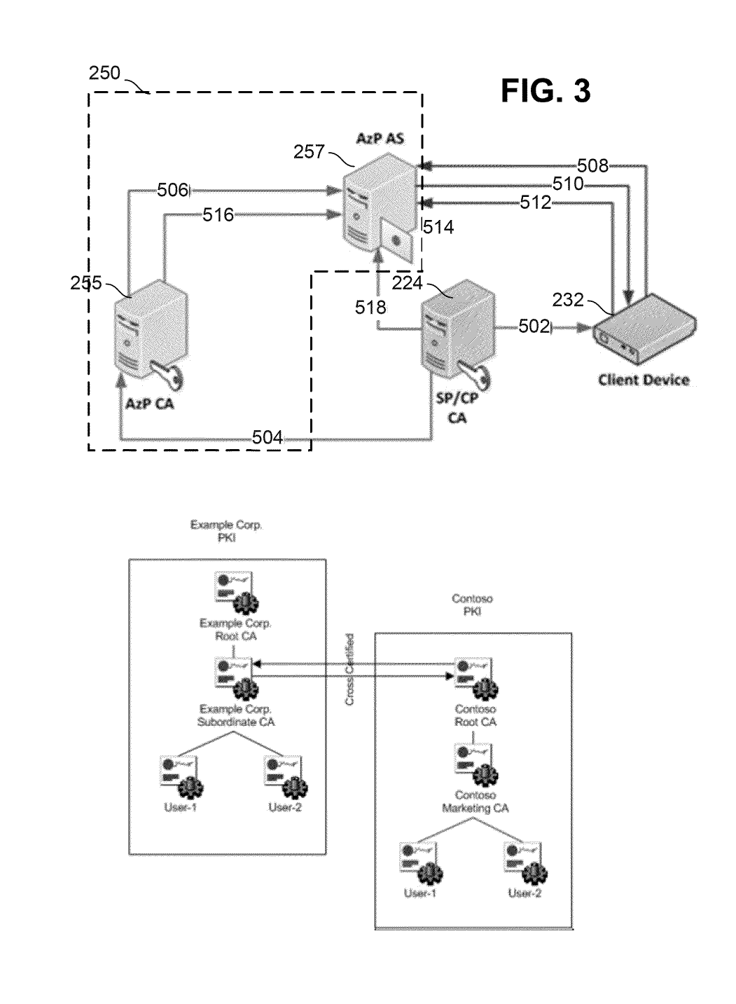

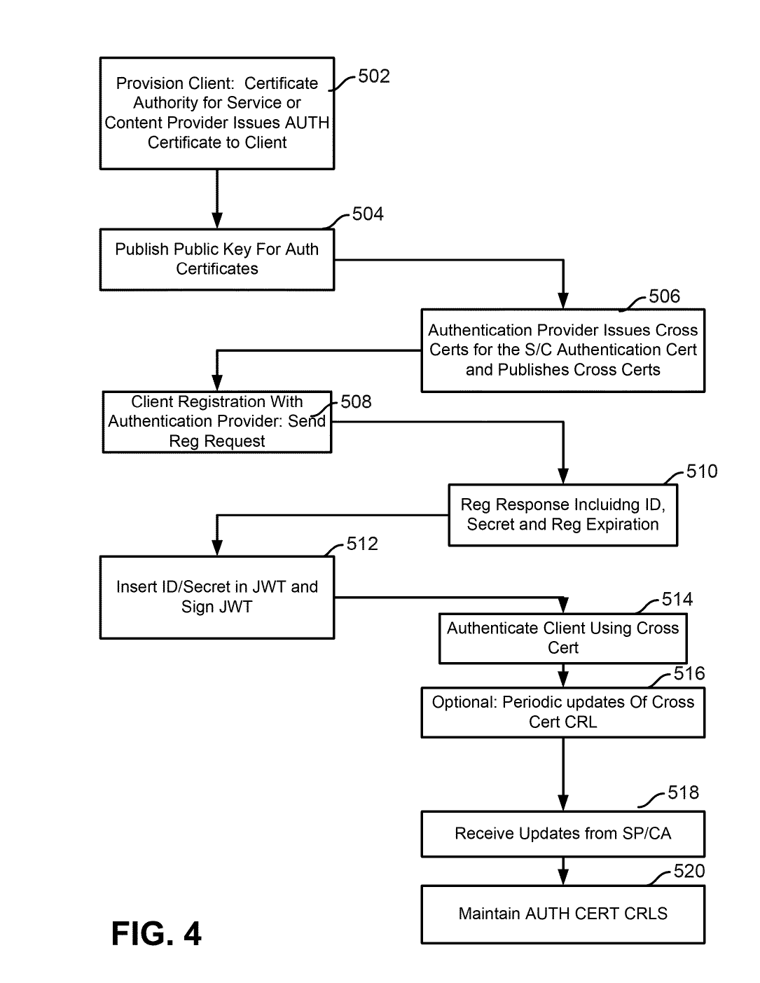

An example of the registration process is illustrated in FIGS. 3 and 4. In FIG. 4, the right side of the figure illustrates actions performed by the authorization provider 250, while the left side of the figure illustrates actions performed by or on the client device. The actions are correlated to the actors in FIG. 3.

At step 502, the client device such as device 232 is initially provisioned when the certificate authority for a service or content protected resource provider issues an authentication certificate (i.e. certificate 238) to the client as part of the provisioning of the protected resource provider's security module on the client. This will include the content or security provider's authentication certificate and private keys.

At 504, the protected resource provider certificate authority publishes one or more public keys spanning the authentication certificates to the certificate authority 255 of the authentication provider 250. At 506, the authentication provider issues cross-certificates to the trusted, published service or content provider public keys and provides them to authentication server 257.

When authentication is needed by the client, the client sends a client registration request to the authentication server 257 at step 508. The client registration request may be encoded as a post to the authentication server as a client registration endpoint, indicating the client authentication method of “private_key_JWT”.

At 508, as a result of the aforementioned steps 502-506, the state of the client device 232 includes a security module (i.e. 236) trusted by the authorization provider and an authentication certificate (238) signed by the protected resource provider who installed the security module. The authorization provider 250 has received public keys from the protected resource provider and has produced cross-certificates to those keys and provided them to the authorization provider's authentication server(s).

At 508, the client provides a registration request to the authentication provider 250 (the authorization server). The client sends a registration request indicating whether this is a new registration (type=client_associate) or an existing registration (type=client_update). The registration request includes the token_endpoint_auth_type parameter set to “private_key_jwt”. An example is provided below:

POST /connect/register HTTP/1.1
Accept: application/x-www-form-urlencoded
Host: server.example.com
type=client_associate
&redirect_uris=https://client.example.com/callback%20https://client.
example.com/callback2
&token_endpoint_auth_type=private_key_jwt

At 510, the authentication server provides a client registration response which includes a client ID, a client nonce, and a client registration expiration. At 510, the authorization provider responds to the client registration request from 508 by returning a JSON object with all of the parameters as top level elements. This includes a client ID, a client secret, and a client registration expiration. The client registration expiration indicates how long the client ID and client secret may continue to be used for Client Authentication. Once the registration has expired, the Client must re-register with the type=client_update, in order to receive a new Client Secret.

HTTP/1.1 200 OK
Content-Type: application/json
Cache-Control: no-store
{

“client_id”:“s6BhdRkqt3”,
“client_secret”:“cf136dc3c1fd9153029bb9c6cc9ecead918bad9887fce
6c93f31185e5885805d”,
“expires_in”:3600

}

At 512, the client inserts its client ID, a cryptographic hash of its client secret in a JSON web token, and uses its private signing key (its protected resource provider specific private sign in key) to sign the JWT. It provides the signed JWT and the device's authentication certificate to the authentication server at 512. This may be provided in an OAuth bearer token assertion.

At 512, the client device security module constructs a JWT and signs the JWT with its signing private key. The JWT includes the client ID and a cryptographic hash of the authentication secret provided by the authentication provider when the device last registered. It also includes a JWT ID to prevent replay attack during the duration of the registration. The JWT ID should be unique and the nonce should match.

At 512, the client next sends its authentication assertion to the authorization provider. This assertion contains: a client ID which was provided in the client registration response; a “grant_type” of “authorization_code”; a “client_assertion_type” of “urn:ietf:params:oauth:client-assertion-type:jwt-bearer”; and a “client_assertion” containing a single JWT encoded for transport within HTTP forms and base64url encoded. One example is:

POST /token HTTP/1.1
Host: server.example.com
Content-Type: application/x-www-form-urlencoded
grant_type=authorization_code&
code=i1WsRn1uB1&
client_id=s6BhdRkqt3&
client_assertion_type=urn%3Aietf%3Aparams%3Aoauth%3Aclient-
assertion-type%3Ajwt-bearer&
client_assertion=PHNhbWxwOI... (

At 514, the authentication server may authenticate the client using the authentication certificate to verify that the client device 232 is a trusted component and verifying the signature and contents of the signed JSON web token. It should be noted that at 516, the authentication provider's certificate authority may periodically update its protected resource provider cross-certificate CRL which is used by the authentication server 257. At 518, the protected resource provider's certificate of authority can revoke authentication certificates that it has issued (in step 502) thereby allowing the protected resource provider control over revocation of the certificates. It may also periodically update the CRL. Resource provider CRL updates are received by the authentication provider 250 at 518. At 520, the authorization provider 250 maintains an up to date authentication certificate CRL and service and content provider cross-certificate CRL, which is utilized in the validation of additional certification at steps 506 through 514.

At 514, the authorization provider verifies the authentication assertion by the client. In order to verify, the following actions may be taken by the authentication provider to verify the Client device's assertion: (1) that the provider is the intended audience of the JWT; (2) that the assertion has not expired; (3) that the authentication certificate is valid by verifying that the authentication certificate is part of the PKI and that it is not on the protected resource provider cross-certification CRL or any of the protected resource provider authentication CRLs; (4) that the nonce and hash in the JWT matches those provided to the client in the client registration response; and (5) that that this assertion is not one previously processed in association with this client ID and client secret

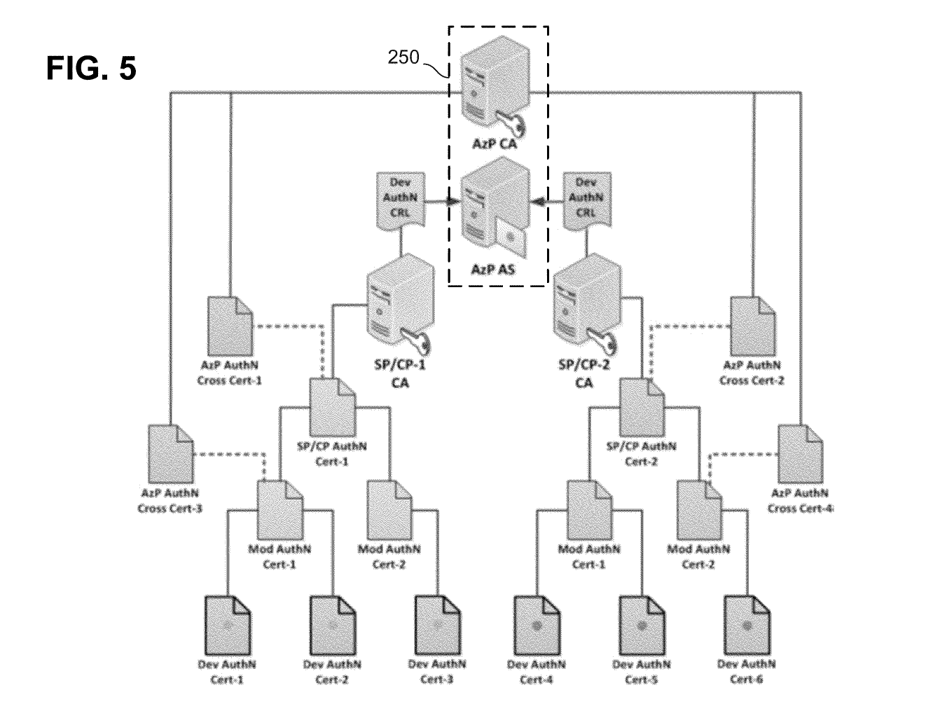

FIG. 5 represents an example of a public key infrastructure topology in accordance with the present technology. As illustrated therein, an authorization provider 250 issues a plurality of cross-certificates (AzP AuthN Cross Cert-1 through AzP AuthN Cross Cert-4). Each protected media provider certificate authority (SP/CP-1 CA, SP/CP-2 CA) issues its own authentication certificates (SP/CP AuthN Cert-1, SP/CP AuthN Cert-2). In this example, public key entry points are created at the level of the individual device models e.g. the model authentication certificates (Mod AuthN Cert-1 and Mod AuthN Cert-2), However, public key cross-certificate entry points may be created at any level of grouping or even the device authentication certificates Dev AuthN Cert-1 through Dev AuthN Cert-6). An authorization provider might prefer to establish certification path to individual models within the trust hierarchy. In this manner, should the authorization provider lose trust in a particular device model protected by that provider, it could revoke trust to one model rather than all devices protected by the particular provider. Each device authentication certificates contain public key certificates signed by the service or content provider certificate of authority. Because the certificate format is standardized by the technology, the digital signed algorithm is also standardized for all authentication certificates.

The present technology provides nonrepudiation by relying on a public key infrastructure, yet scales well as it does not depend on a single, monolithic certificate authority. Although the technology utilizes a client device possessing an authentication secret, for security, the protocol implements robust client security for that secret and thus the client may advantageously prove possession of the secret when authenticating. The protocol is based on widely adopted standards, but for security, relies on the existence of some licensed component on the client device which is subject to legally binding robustness and compliance rule

FIG. 6 illustrates an example of a suitable computing system environment 900 such as computer in which the technology may be implemented. The computing system environment 900 is only one example of a suitable computing environment and is not intended to suggest any limitation as to the scope of use or functionality of the technology. Neither should the computing environment 900 be interpreted as having any dependency or requirement relating to any one or combination of components illustrated in the exemplary operating environment 900.

Any of the aforementioned clients, servers or processing devices mentioned herein may comprise device 900. The technology is operational with numerous other general purpose or special purpose computing system environments or configurations. Examples of well-known computing systems, environments, and/or configurations that may be suitable for use with the technology include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The technology may be described in the general context of computer-executable instructions, such as program modules, being executed by a computer. Generally, program modules include routines, programs, objects, components, data structures, etc. that perform particular tasks or implement particular abstract data types. The technology may also be practiced in distributed computing environments where tasks are performed by remote processing devices that are linked through a communications network. In a distributed computing environment, program modules may be located in both local and remote computer storage media including memory storage devices.

With reference to FIG. 6, an exemplary system for implementing the technology includes a general purpose computing device in the form of a computer 910. Components of computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 910 typically includes a variety of computer readable media. Computer readable media can be any available media that can be accessed by computer 910 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 910.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 6 illustrates operating system 934, application programs 935, other program modules 936, and program data 939.

The computer 910 may also include other tangible removable/non-removable, volatile/nonvolatile computer storage media. By way of example only, FIG. 6 illustrates a hard disk drive 940 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through an non-removable memory interface such as interface 940, and magnetic disk drive 951 and optical disk drive 955 are typically connected to the system bus 921 by a removable memory interface, such as interface 950.

The drives and their associated computer storage media discussed above and illustrated in FIG. 6, provide storage of computer readable instructions, data structures, program modules and other data for the computer 910. In FIG. 6, for example, hard disk drive 941 is illustrated as storing operating system 944, application programs 945, other program modules 946, and program data 949. Note that these components can either be the same as or different from operating system 934, application programs 935, other program modules 936, and program data 939. Operating system 944, application programs 945, other program modules 946, and program data 949 are given different numbers here to illustrate that, at a minimum, they are different copies. A user may enter commands and information into the computer 20 through input devices such as a keyboard 962 and pointing device 961, commonly referred to as a mouse, trackball or touch pad. Other input devices (not shown) may include a microphone, joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). A monitor 991 or other type of display device is also connected to the system bus 921 via an interface, such as a video interface 990. In addition to the monitor, computers may also include other peripheral output devices such as speakers 999 and printer 996, which may be connected through a output peripheral interface 990.

The computer 910 may operate in a networked environment using logical connections to one or more remote computers, such as a remote computer 980. The remote computer 980 may be a personal computer, a server, a router, a network PC, a peer device or other common network node, and typically includes many or all of the elements described above relative to the computer 910, although only a memory storage device 981 has been illustrated in FIG. 9. The logical connections depicted in FIG. 9 include a local area network (LAN) 991 and a wide area network (WAN) 993, but may also include other networks. Such networking environments are commonplace in offices, enterprise-wide computer networks, intranets and the Internet.

When used in a LAN networking environment, the computer 910 is connected to the LAN 991 through a network interface or adapter 990. When used in a WAN networking environment, the computer 910 typically includes a modem 992 or other means for establishing communications over the WAN 993, such as the Internet. The modem 992, which may be internal or external, may be connected to the system bus 921 via the user input interface 960, or other appropriate mechanism. In a networked environment, program modules depicted relative to the computer 910, or portions thereof, may be stored in the remote memory storage device. By way of example, and not limitation, FIG. 6 illustrates remote application programs 985 as residing on memory device 981. It will be appreciated that the network connections shown are exemplary and other means of establishing a communications link between the computers may be used.

FIG. 7 is a block diagram of one embodiment of a computing system that can be used to implement any of the clients discussed herein. In this embodiment, the computing system is a multimedia console 800, such as a gaming console. As shown in FIG. 8, the multimedia console 800 has a central processing unit (CPU) 801, and a memory controller 802 that facilitates processor access to various types of memory, including a flash Read Only Memory (ROM) 803, a Random Access Memory (RAM) 806, a hard disk drive 808, and portable media drive 806. In one implementation, CPU 801 includes a level 1 cache 810 and a level 2 cache 812, to temporarily store data and hence reduce the number of memory access cycles made to the hard drive 808, thereby improving processing speed and throughput.

CPU 801, memory controller 802, and various memory devices are interconnected via one or more buses (not shown). The details of the bus that is used in this implementation are not particularly relevant to understanding the subject matter of interest being discussed herein. However, it will be understood that such a bus might include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

In one implementation, CPU 801, memory controller 802, ROM 803, and RAM 806 are integrated onto a common module 814. In this implementation, ROM 803 is configured as a flash ROM that is connected to memory controller 802 via a PCI bus and a ROM bus (neither of which are shown). RAM 806 is configured as multiple Double Data Rate Synchronous Dynamic RAM (DDR SDRAM) modules that are independently controlled by memory controller 802 via separate buses (not shown). Hard disk drive 808 and portable media drive 805 are shown connected to the memory controller 802 via the PCI bus and an AT Attachment (ATA) bus 816. However, in other implementations, dedicated data bus structures of different types can also be applied in the alternative.

A graphics processing unit 820 and a video encoder 822 form a video processing pipeline for high speed and high resolution (e.g., High Definition) graphics processing. Data are carried from graphics processing unit (GPU) 820 to video encoder 822 via a digital video bus (not shown). Lightweight messages generated by the system applications (e.g., pop ups) are displayed by using a GPU 820 interrupt to schedule code to render popup into an overlay. The amount of memory used for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resync is eliminated.

An audio processing unit 824 and an audio codec (coder/decoder) 826 form a corresponding audio processing pipeline for multi-channel audio processing of various digital audio formats. Audio data are carried between audio processing unit 824 and audio codec 826 via a communication link (not shown). The video and audio processing pipelines output data to an NV (audio/video) port 828 for transmission to a television or other display. In the illustrated implementation, video and audio processing components 820-828 are mounted on module 214.

Console 800 may include a security module 827 comprising a hardware element protecting the private key or other device secret via both programmable and physical means. Examples of suitable hardware elements include a Trusted Platform Module (TPM), a smartcard, or any secure cryptoprocessor or storage device that can store cryptographic keys that protect information.

FIG. 8 shows module 814 including a USB host controller 830 and a network interface 832. USB host controller 830 is shown in communication with CPU 801 and memory controller 802 via a bus (e.g., PCI bus) and serves as host for peripheral controllers 804(1)-804(4). Network interface 832 provides access to a network (e.g., Internet, home network, etc.) and may be any of a wide variety of various wire or wireless interface components including an Ethernet card, a modem, a wireless access card, a Bluetooth module, a cable modem, and the like.

In the implementation depicted in FIG. 8 console 800 includes a controller support subassembly 840 for supporting four controllers 804(1)-804(4). The controller support subassembly 840 includes any hardware and software components needed to support wired and wireless operation with an external control device, such as for example, a media and game controller. A front panel I/O subassembly 842 supports the multiple functionalities of power button 812, the eject button 813, as well as any LEDs (light emitting diodes) or other indicators exposed on the outer surface of console 802. Subassemblies 840 and 842 are in communication with module 814 via one or more cable assemblies 844. In other implementations, console 800 can include additional controller subassemblies. The illustrated implementation also shows an optical I/O interface 835 that is configured to send and receive signals that can be communicated to module 814.

MUs 840(1) and 840(2) are illustrated as being connectable to MU ports “A” 830(1) and “B” 830(2) respectively. Additional MUs (e.g., MUs 840(3)-840(6)) are illustrated as being connectable to controllers 804(1) and 804(3), i.e., two MUs for each controller. Controllers 804(2) and 804(4) can also be configured to receive MUs (not shown). Each MU 840 offers additional storage on which games, game parameters, and other data may be stored. In some implementations, the other data can include any of a digital game component, an executable gaming application, an instruction set for expanding a gaming application, and a media file. When inserted into console 800 or a controller, MU 840 can be accessed by memory controller 802. A system power supply module 850 provides power to the components of gaming system 800. A fan 852 cools the circuitry within console 800. A microcontroller unit 854 is also provided.

An application 860 comprising machine instructions is stored on hard disk drive 808. When console 800 is powered on, various portions of application 860 are loaded into RAM 806, and/or caches 810 and 812, for execution on CPU 801, wherein application 860 is one such example. Various applications can be stored on hard disk drive 808 for execution on CPU 801.

Gaming and media console 800 may be operated as a standalone system by simply connecting the system to a monitor, a television, a video projector, or other display device. In this standalone mode, gaming and media console 800 enables one or more players to play games, or enjoy digital media, e.g., by watching movies, or listening to music. However, with the integration of broadband connectivity made available through network interface 832, gaming and media console 800 may further be operated as a participant in a larger network gaming community.

Each security module discussed herein my be stored in ROM or RAM memory of the above devices of FIGS. 6 and 7 and code instructing the respective processing devices used to implement the security modules in accordance with the description herein. Similarly, all certificates and keys may be provided in the aforementioned memory components of these devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of protecting a resource by authenticating client devices, comprising:
receiving a plurality of public keys from a resource protection provider, the public keys associated an authentication certificate from the resource protection provider and with private keys installed in a group of client devices;
issuing cross-certificates for the public keys and publishing the cross-certificates; and
verifying availability of a protected resource for a client device by authenticating client devices in response to client authentication requests by validating the request using one of said cross-certificates which cryptographically binds one of said public keys previously paired with one of said private keys on the client device.

2. The method of claim 1 wherein each client device includes a first security module including a first security protocol and signing algorithm from a media provider and a second security module performing said receiving, issuing and verifying steps.

3. The method of claim 1 wherein each authentication certificate comprises a root node for one or more client devices.

4. The method of claim 1 wherein said verifying comprises receiving a signed authentication request from a client;
responding to the authentication request with at least a nonce;
receiving a authentication response including the nonce signed with a private key from the client; and
authenticating the client by verifying a signature of the client using one of the cross-certificate and the secret provided in the registration response.

5. The method of claim 1 wherein the authentication certificate includes at least a first extension identifying the public key is used for verifying digital signatures.

6. The method of claim 1 wherein each media provider may issue one or more authentication certificates and further including the steps of receiving a revocation of the authentication certificate from a resource protection provider, the revocation correspondingly revoking an the authentication certificate and an associated cross-certificate.

7. The method of claim 1 further including the step of periodically updating the cross-certificates upon receipt of new public keys from media providers.

8. A media display device capable of requesting a protected resource, the device including a processor, comprising:
a first security module including a first security protocol and signing algorithm from a resource protection provider;
a second security module, the second security module including:
at least one authentication certificate from an authentication provider and an associated private key;
code instructing the processor to request authentication from an authentication provider by signing a communication to the provider using the private key, the authentication provider verifying availability of a protected resource for the media display device in response to the request by authenticating the request through a cross-certificate to the resource protection provider, the cross-certificate cryptographically binding a public key paired with the private key.

9. The device of claim 8 wherein the code further includes code instructing the processor to request authorization from the authentication provider using the cross-certificate to the resource protection provider.

10. The device of claim 8 wherein the cross-certificate is tied to a group of devices.

11. The device of claim 8 wherein the cross-certificate includes at least a first extension identifying the public key is used for verifying digital signatures.

12. The device of claim 11 wherein the cross-certificate includes a one or more standard digital rights management certifications.

13. The device of claim 8 wherein said communication comprises a signed request including a client ID and an authentication secret previously received from the authentication service.

14. A method of authenticating a plurality of client devices, at least one client device including a first authentication scheme and at least one client device including a second authentication scheme, the second authentication scheme including the method comprising:
receiving a plurality of public keys and security module-specific certificates from protected resource protection providers, each key signed by the resource protection provider;
issuing authentication cross-certificates for the public keys and publishing the authentication cross-certificates;
receiving an authentication request from a client;
responding to the authentication request with an identifier and a secret;
receiving an authentication response including the identifier and the secret signed with a private key from the client; and
authenticating the client device by verifying a signature of the client using the authentication cross-certificate and information provided in the authentication response.

15. The method of claim 14 wherein the public keys are used for the method and the first authentication scheme.

16. The method of claim 15 wherein issuing authentication cross-certificates includes issuing certificates for one or more groups of client devices.

17. The method of claim 15 wherein issuing authentication cross-certificates includes issuing certificates for individual client devices.

18. The method of claim 15 further including the steps of receiving a revocation of the authentication certificate from a media provider, the revocation correspondingly revoking an associated cross-certificate.

19. The method of claim 16 wherein the cross-certificate includes at least a first extension identifying the public key is used for verifying digital signatures.

20. The method of claim 16 wherein a first protected resource provider issues public keys for devices having the first authentication scheme, and a second protected resource provider issues public keys for devices having the second authentication scheme.
